(19) United States
(12) Patent Application Publication
(10) Pub. No.: US 2015/0300547 A1
(43) Pub. Date: Oct. 22, 2015

(54) COMPACT PUSH-PULL FEMALE QUICK COUPLING

(71) Applicant: FASTER S.P.A., Milano (IT)

(72) Inventors: Luigi CANZI, Melzo (IT); Roberto SORBI, Rivolta d'Adda (IT); Paolo RUSCONI, Rivolta d'Adda (IT)

(73) Assignee: FASTER S.P.A., Milano (IT)

(21) Appl. No.: 14/646,301

(22) PCT Filed: Nov. 21, 2012
(86) PCT No.: PCT/IB2012/056587

§ 371 Date: May 20, 2015

(51) Int. Cl. F16L 37/32

(52) U.S. Cl. CPC F16L 37/32

(57) ABSTRACT

The present invention relates to a female quick coupling (10) of the type comprising an axial valve body (11) for closing the flow of fluid in the fitting, characterised in that it comprises a mechanical locking device (30) of the valve body, wherein thanks to the new type of mechanical locking device, the quick coupling, of the push-pull type, according to the present invention is particularly compact, simple to produce and therefore reliable and easy to assemble.

### DESCRIPTION OF THE INVENTION

The present invention relates to a compact push-pull quick coupling, that is suitable for being connected to a corresponding male coupling by means of an axial push-pull movement.

### STATE OF THE ART

As is known in the prior art, quick coupling comprise a male coupling and a female coupling, and in general each of said male and female fittings internally comprises numerous components, including the valve bodies necessary for the closure of the fitting when said fitting is uncoupled and pressurised fluid is present within it.

The presence of a valve body suitable for closing the flow of the fluid is also very important in that it allows the connection and disconnection of the fitting even when there is pressurised fluid in one of the two fittings.

In particular, the present invention concerns a female quick coupling comprising within it a valve body and a locking device of said valve body of the female fitting, suitable for firmly maintaining the valve body in an open position.

As is known in the prior art, when the female fitting and the male fitting are coupled to each other and the valve body of the female fitting is maintained in an open position, the valve body of the male fitting is also maintained in an open position.

The return flow in the case of high flow rates is thus prevented.

The type of fitting being discussed has been known on the market for several years, and is used in the agricultural sector in particular. The fittings currently known from the prior art and present on the market present as drawback the fact that they have dimensions that are not contained and a high structural complexity on account of the high number of inner components, in particular those components producing the, generally hydraulic, valve body locking system.

As mentioned, the couplings of the type being discussed, equipped with a valve body locking system and known in the prior art present a, generally hydraulic, valve body locking system. The aim of the present invention is therefore that of providing a female coupling equipped with a mechanical locking device that is extremely compact and produced with a contained number of elements, so as to also result, in addition to having minimum dimensions, more reliable with respect to the solutions known in the prior art.

### SUMMARY OF THE INVENTION

The main aim of this invention is thus that of resolving the drawbacks set out thus far and other drawbacks that afflict fittings with valve locking systems of the type known from the prior art.

In particular, within said main aim, the object of the present invention is that of providing a compact female coupling of the push-pull type equipped with a mechanical locking device of the valves that is particularly simple from a structural point of view and, consequently, reliable and having reduced dimensions.

This aim and these and other objects, which will become clearer from the remainder of the document, are achieved by a compact female coupling of the push-pull type equipped with mechanical locking of the valve unit, as claimed in the accompanying claims.

### BRIEF DESCRIPTION OF THE DRAWINGS

Further characteristics and advantages of the present invention shall become clearer from the following detailed description, provided by way of a non-limiting example and illustrated in the accompanying drawings, wherein:

FIG. 1 shows a perspective view in partial cross section of the female quick coupling according to the present invention;

FIG. 1A shows a detail, the forked cam, of the mechanical locking device characterising the female quick coupling according to the present invention;

FIG. 1B shows a detail, the valve guide, of the mechanical locking device characterising the female quick coupling according to the present invention;

FIG. 2 shows a detail of the mechanical locking device, with assembled forked cam and valve guide, of the valve unit of the coupling according to the present invention;

FIG. 2A shows a detail of the inner body of the quick coupling according to the present invention;

FIGS. 3 to 12 again show in a perspective view in partial cross section various stages of the insertion of a male coupling into the female coupling according to the present invention and some details, as will be better explained below;

FIG. 13 shows a detail of the inner body and the valve guide with the compression-torsions spring.

### DETAILED DESCRIPTION OF THE INVENTION

According to a preferred embodiment of the present invention illustrated in the aforementioned drawings by way of a non-limiting example, the female coupling 10 has a substantially cylindrical shape and comprises within it a plurality of components also having cylindrical symmetry. In particular, in axial position and axially moveable, said female coupling 10 comprises a valve body 11, having a substantially cylindrical form and presenting an end valve 12 adapted to coming into contact with the end valve 22 of a valve body 21 envisaged in the male coupling 20.

As mentioned, the female coupling 10 according to the present invention is a mechanical locking device 30 of the valve body 11.

Said mechanical locking device 30 comprises, a valve guide 31, having a substantially cylindrical form and comprising at least one pair of grooves 31a envisaged in a diametrically opposed position on the outer surface of said valve guide 31, and a forked cam 32 also having a substantially cylindrical form and in turn comprising at least one pair or rods 33, each of which presents a free end 33b having an oblique profile that defines an inclined plane with respect to the longitudinal coupling direction.

The grooves 31a envisaged in the zone to the rear of said valve guide 31 are adapted to house said rods 33 of said forked cam, which extend towards the front part of the coupling from the forked cam 32, and also a portion 31b of the inlet edge of said grooves 31a intended to come into contact with the free end 33b of said rods 33 is suitably shaped with a profile that is complementary to the oblique profile of said free ends 33b of said rods 33, so as to make possible the relative sliding of the two inclined surfaces or slides, the end ones 33b and the inlet one 31b, as will be better described below when illustrating the operation of the device. Said mechanical locking device 30 further comprises locking means of the valve guide 31 in the open position of the valve body 11. Said locking means of the valve guide 31 comprise a compression-torsion spring 34 of the valve guide 31. Said compression-torsion spring 34 works between said valve guide 31 and an inner body 40 which also has a substantially cylindrical hollow for that is axially mobile with respect to an outer body 50 of said female coupling. Said inner body 40 presents a suitable housing 41 for a peg or pin 35 which is therefore integral with said inner body 40. Said peg 35 internally extending to the coupling in a radial direction and inserting itself in a sectioned groove 36 envisaged on the outer surface of said valve guide 31.

The sectioned groove 36 presents a first portion 36a, next to the rear portion of the said valve guide 31, having a greater width, and a second portion 36b that develops longitudinally towards the front portion of said valve guide 31, the lesser width that is substantially the same as the width, or as the diameter in the case of cylindrical peg as in the example shown in the accompanying figures, of said peg 35.

The terms “front” and “rear” in the present description relate to the female coupling in question. The end of the female coupling intended to be inserted into the male coupling is therefore understood as the front end and the coupling connected to the line as the rear end. Analogously therefore, the front portion of the valve guide is the portion next to the front end of the coupling.

La variation of the width of the portions 36a and 36b of the sectioned groove 36, determines a connection zone 37 that constitutes an abutment for said peg 35, the connection zone of which can advantageously be shaped so as to more firmly house the peg 35. In particular, with reference to the embodiment illustrated in the accompanying drawings, said connection zone 37 may present an recess 37a having a suitable curvature ratio for housing the circular profile of the peg 35, so that the latter may not accidentally slip out of this recess 37a.

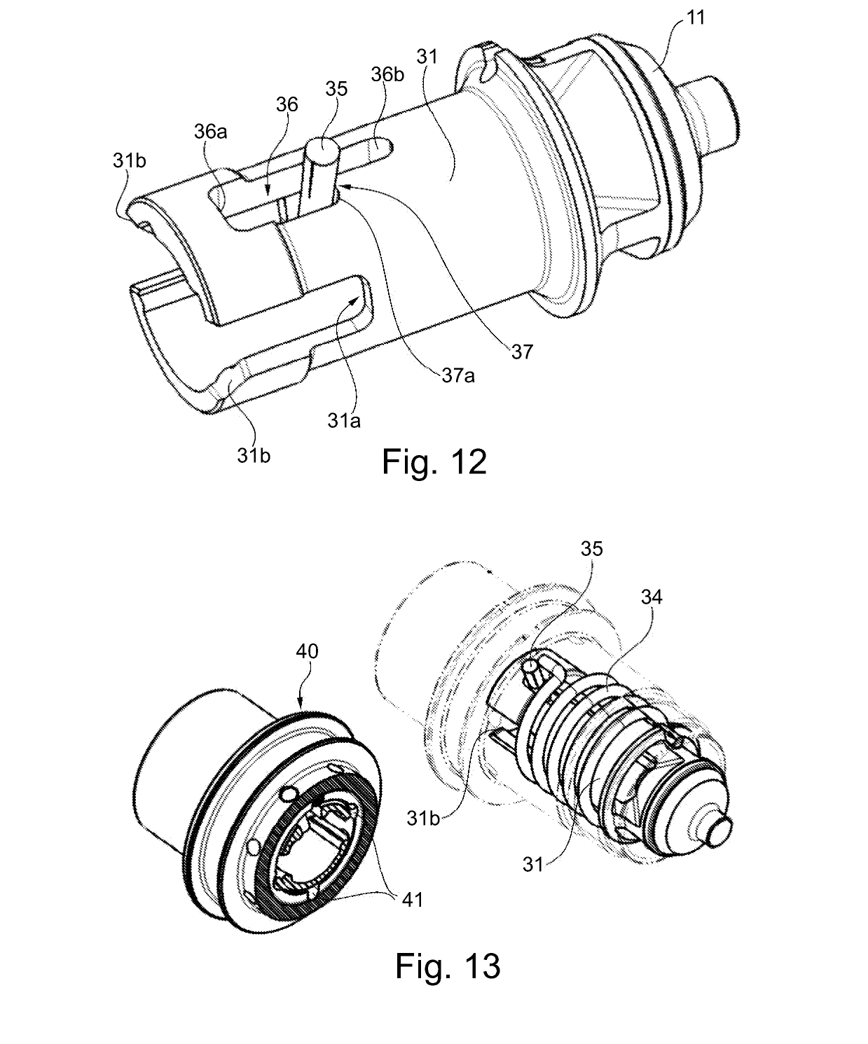

According to the above description and as can be seen in FIG. 12, for example, the peg 35 moves along the sectioned groove 36 in the relative movements between said valve guide 31 and said inner body 40, with which said peg 35 is integral.

In particular, it will be more clearly seen below in describing the operation of the coupling according to the present invention, how said valve guide 31 can move along the longitudinal direction of the coupling and can rotate about the axis thereof in relation to the inner body 40 of the female coupling. During the relative movement of the valve guide in respect of the inner body 40, the peg 35, which is integral to the inner body 40, slides in relation to the valve guide 31 within the sectioned groove 36, first travelling along the rear portion 36a of said groove until it reaches said connection zone 37. In order release the peg 35 from the connection zone 37, in particular from the recess 37a specially formed to prevent the peg from accidentally slipping out of the indentation itself, the valve guide 31 must complete a rotation about the axis thereof in relation to the inner body 40, in the direction indicated by the arrows in the accompanying drawings—that results in a movement of the peg 35 from the rear portion 36a towards the portion 36b, which extends towards the front part of the valve guide 31.

Said locking means of the valve guide therefore prevent the valve guide from moving backward or forward by effect of the pressure of the fluid.

The operation of the mechanical locking device 30 of the female coupling according to the present invention will now be illustrated with reference to the accompanying drawings, which show the connection steps of the male coupling 20 with the female coupling 10.

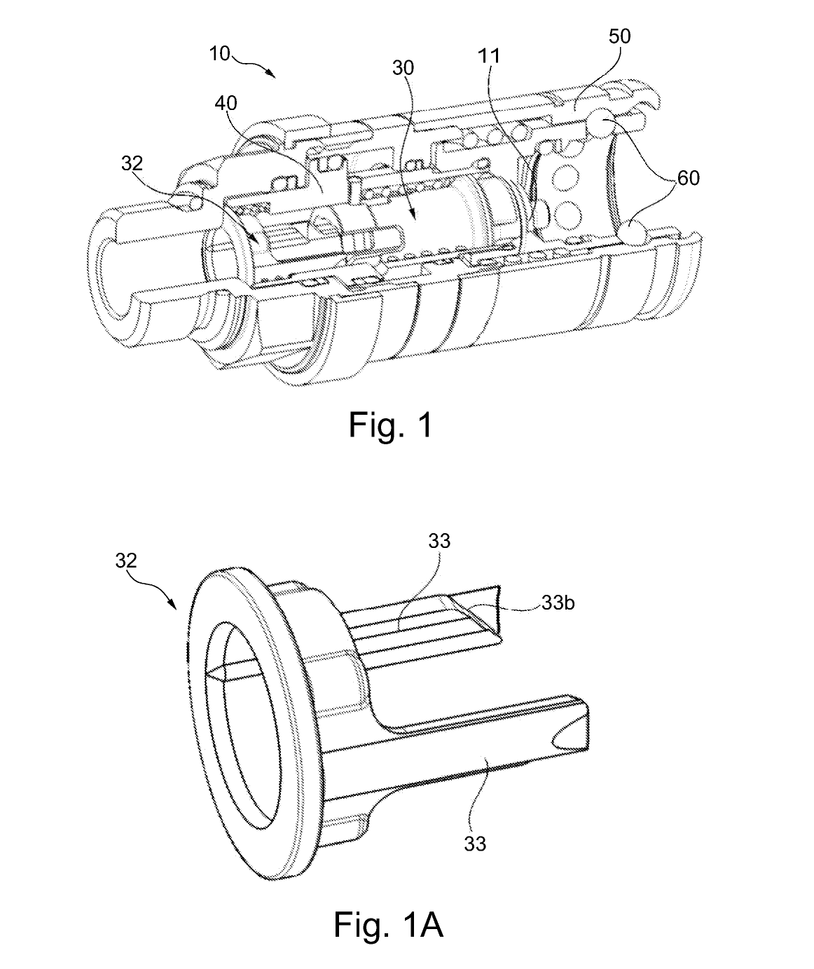

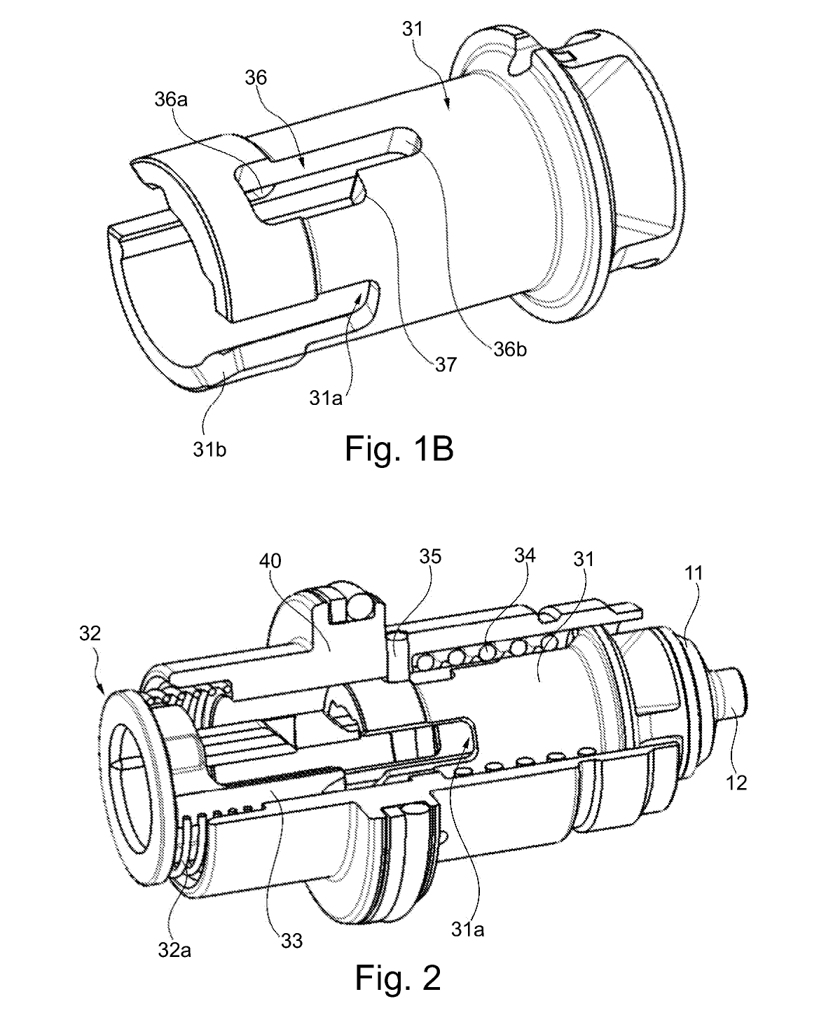

With reference to FIG. 1, when the female coupling and the male coupling are uncoupled the valve body 11 of the female coupling closes the axial passage for the fluid, being maintained in a forward closed position by the helical compression-torsion spring 34 which acts between said valve guide 31 and the inner body 40, and the mechanical locking device 30 therefore finds itself in the position visible in FIG. 1, wherein said valve guide 31 is in the forward valve closure position, as mentioned, the forked cam 32 is maintained in a position retracted from the action of the spring of the forked cam 32a, which acts between said forked cam 32 and said inner body 40 opposing the approach of the forked cam 32 to said valve guide

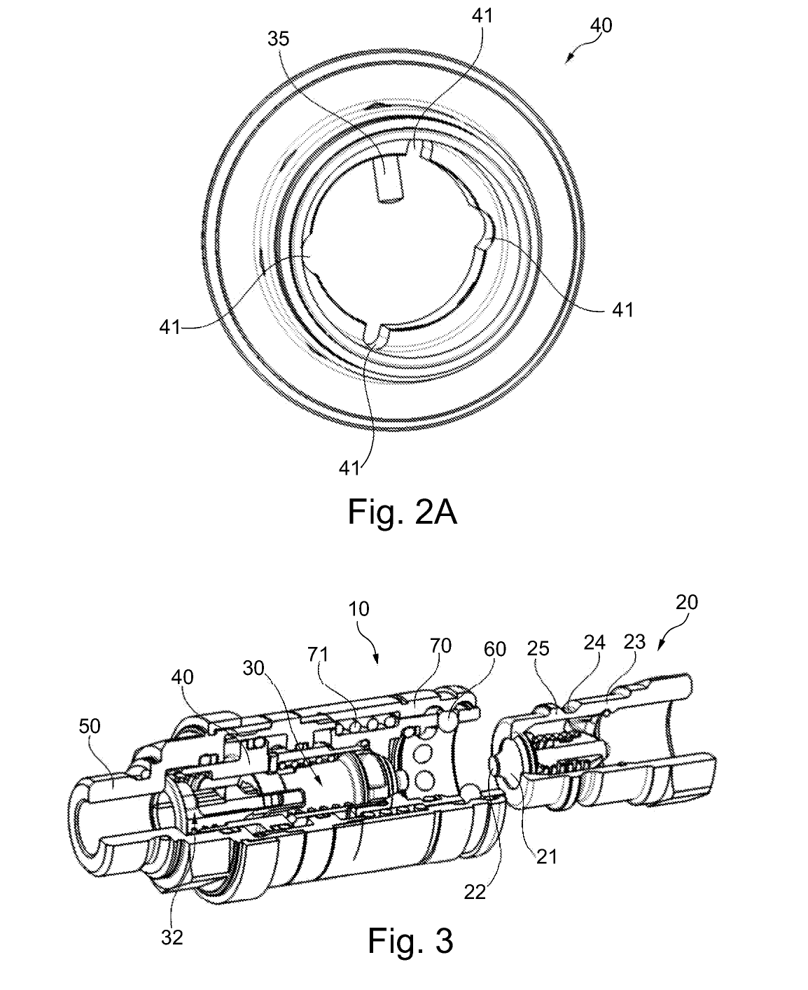

In order to guide the forked cam 32 into the translatory movement thereof in relation to the inner body 40, the latter is provided with guide grooves 41, that are visible for example in the details of FIGS. 2A and 13.

In this configuration of an unconnected male coupling and thus valve body 11 of the female coupling 10 in a closed position, the peg 35 is inserted in the sectioned groove 36 envisaged on the outer surface of said valve guide 31 at the level of the rear end of the first portion 36a of said groove. Once again with reference to FIGS. 1 and 3, the rods 33 of the forked cam 32 are not in contact with said valve guide 31, which can therefore move backward by effect of the thrust exercised by the valve body 21 of the male coupling 20 when the male is inserted into the female coupling.

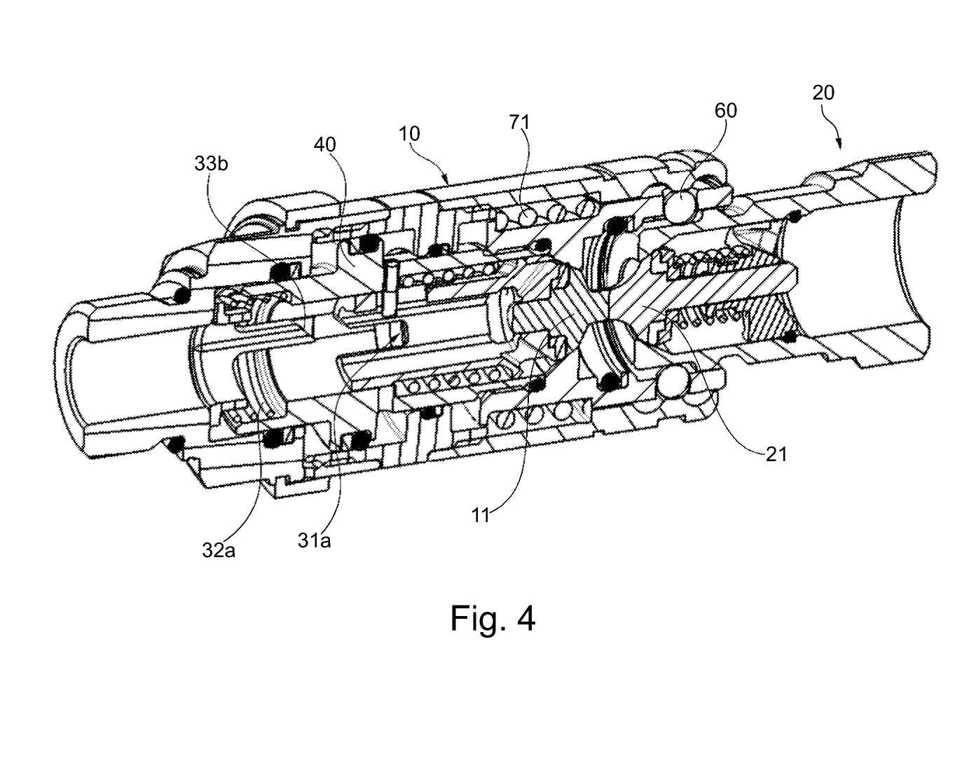

FIG. 4 represents the condition in which the valve body 21 of the male coupling comes into contact with the valve body 11 of the female coupling, the latter nevertheless remaining in the forward closed position of the coupling.

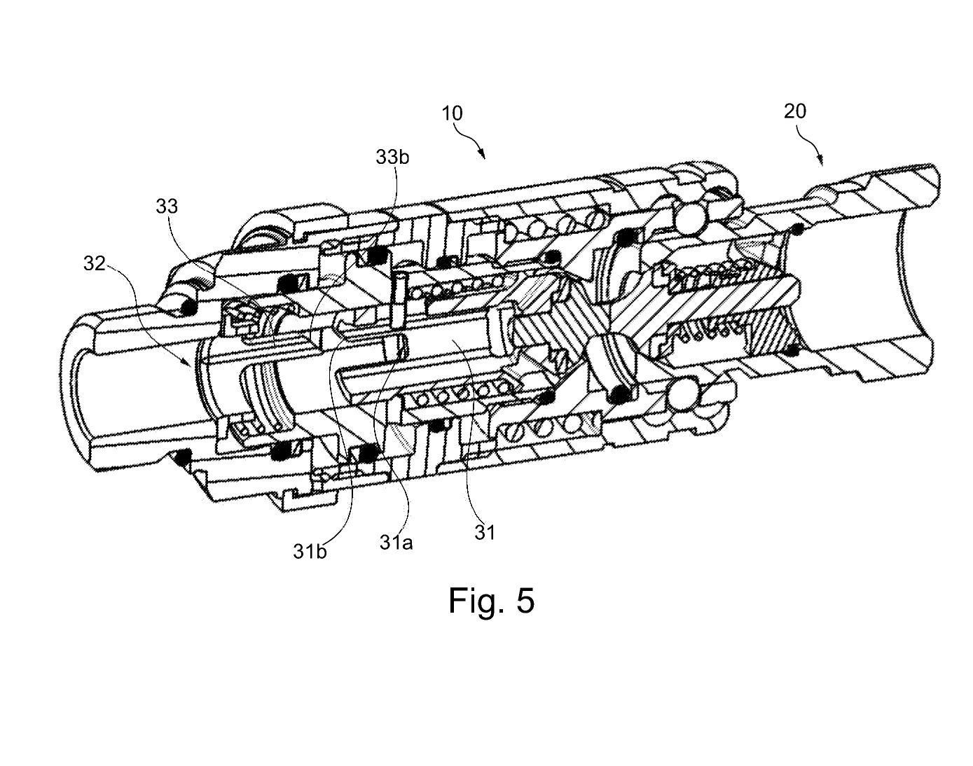

The subsequent step, shown in FIG. 5, envisages that insertion of the male coupling results in the opening of the valve body of the female coupling. This is obtained in that the male coupling is subjected to internal pressure. The valve of the male is thus pushed by the hydrostatic pressure, beyond the elastic spring associated thereto, while the valve body 11 of the female coupling, and with it the valve guide 31 moves backward resulting in compression of the compression-torsion spring 34. At the same time the outer body 23 of the male coupling tangentially rests on the locking balls 60 of the female coupling that are radially pushed outwards by the profile 25 of the outer body 23.

Continuing with the insertion of the male coupling, the valve of the male begins to open the valve of the female coupling, according to what is still visible in FIG. 5. The ball housing 70 within which the locking balls are radially mobile 60 is dragged backward, i.e. towards the rear zone of the female coupling, by the thrust action of the male and therefore moves backward both the mechanical locking device 30, in particular the valve guide 31 with all the elements associated thereto, bringing the rear edge of said valve guide closer 31, in particular with the portion 31b of the inlet edge of the grooves 31a, to the rods 33 of the forked cam 32.

The backward movement of the valve body 11 and of the valve guide 31 causes compression of the decompression-torsion spring 34 of the valve guide 31 and of said forked cam spring 32a that is compressed by the backward movement of the inner body 40.

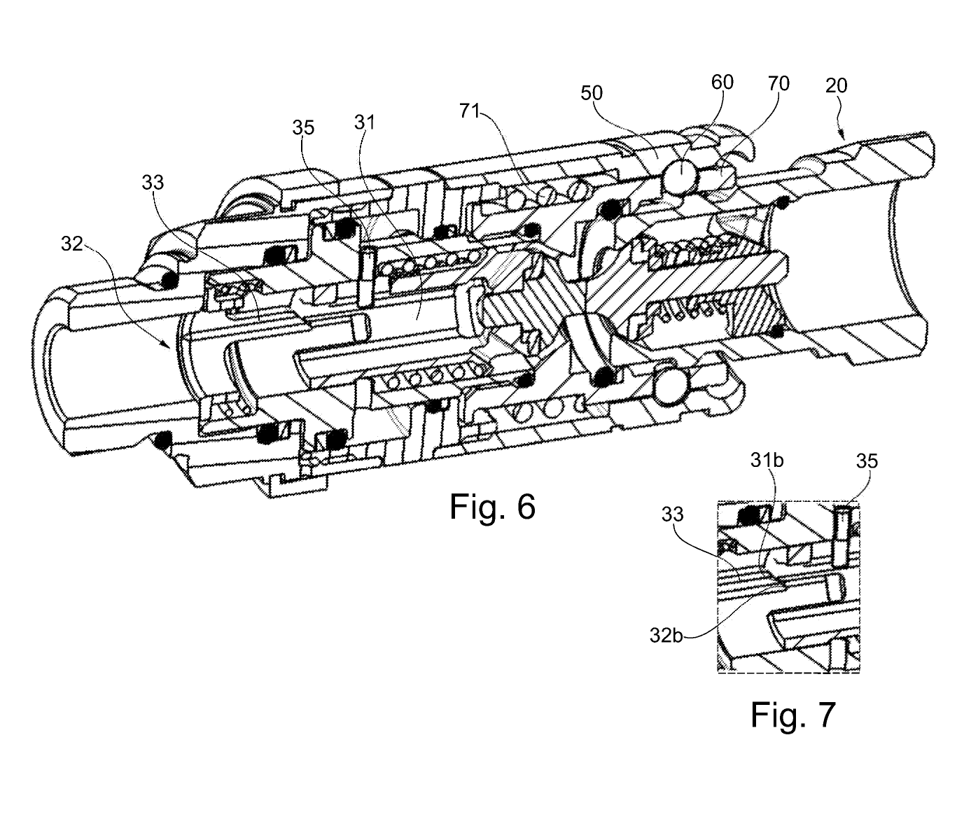

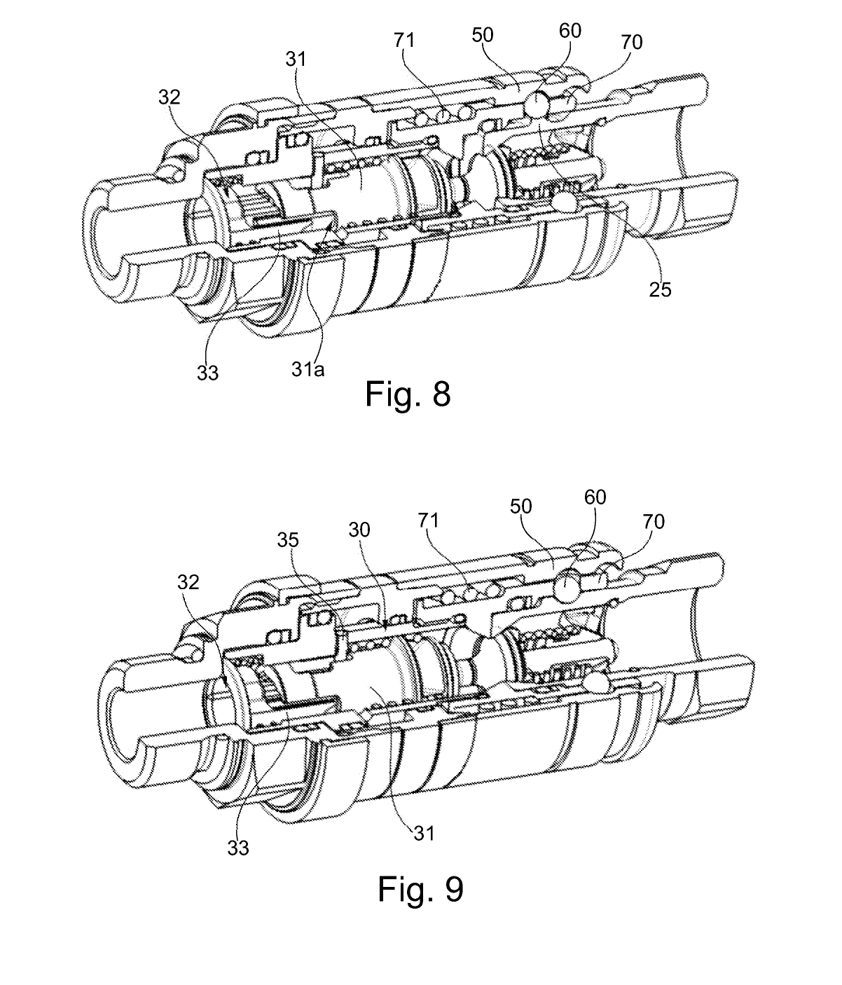

With particular reference to FIG. 6 and to the detail of FIG. 7, in this step the valve guide 31 moves backward towards the rear part of the coupling translating without completing any rotation about the axis thereof. In this step, the peg 35 that is longitudinally mobile integrally to the inner body 40, guides the valve guide 31 in the longitudinal axial translation thereof sliding within the sectioned groove 36. In particular, the valve guide 31, in the axial movement thereof in relation to the peg 35, the latter slides within the first portion 36a of the sectioned groove 36 thus allowing the backward movement of the valve guide 31.

When the rods 33 of the forked cam 32 come into contact with the portion 31b of the inlet edge of the grooves 31a by effect of the backward movement of the valve guide 31, the oblique profile, i.e. inclined in respect of the longitudinal direction, of the ends results in rotation of the valve guide 31 about the longitudinal axis thereof until said rods 33 find the grooves 31a envisaged in the rear zone of said valve guide 31 and adapted to house said rods 33. The peg 35 is in this way aligned with the front portion 36b of said sectioned groove 36 thus allowing backward movement of the valve guide 31, with said peg sliding within the front portion 36b of the groove 36 and the rods 33 of the forked cam 32 entering the grooves 31a of said valve guide 31.

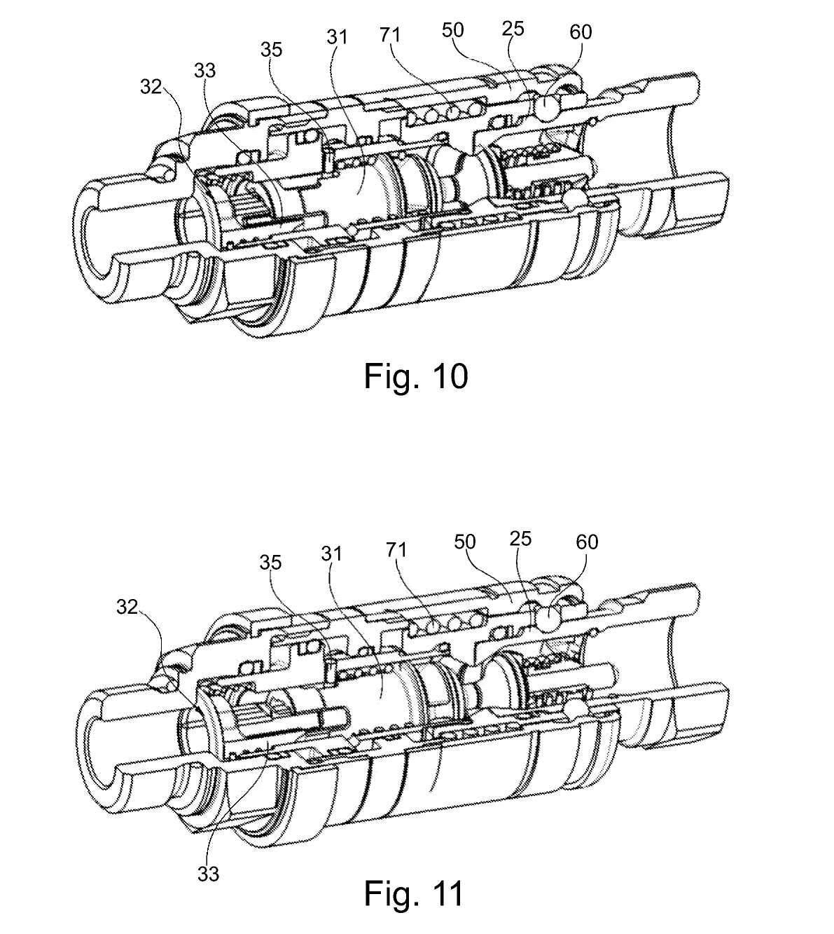

Under the thrust action of the valve body 21 of the male coupling, thus, the valve guide 31 rotates about is own axis, the peg 35 reinserts itself in the second portion 36b and the valve guide moves further back allowing the male coupling to be inserted into the female coupling. In this step, the locking balls 60 surmount the outer profile 25 of said outer body 23 of the male coupling and fall into the circumferential seat 24. As mentioned, the locking balls 60 are inserted into the ball housing 70 and are radially mobile between a first position in which they are housed in a special seat obtained in the inner surface of the outer body 50, thus constraining said ball housing 70 with respect to said outer body 50, and a second position in which the radially fall into the circumferential seat 24 of the male coupling. The situation is shown in FIGS. 10 and 11, thus producing a constraint between said ball housing 70 and said outer body 23 of the male coupling.

Thus at this point, the inner body 40 of the female coupling, the valve guide 31 and the ball housing 70 return to advancing towards the front portion of the female coupling under the thrust of a compression spring of the ball housing 71, which acts between said ball housing and said outer body 50 of said female coupling.

Up until this point, the male valve was still closed, pushed by the hydrostatic pressure of the fluid affecting the male coupling.

Now that insertion of the male into the female has been completed, the locking balls 60 being correctly in position to retain the male coupling, pressure can be introduced into the female coupling. The situation is shown in FIG. 11. In this step the valve guide unit 31 moves the valve of the male 21 opening the passage of the flow of oil, and an equilibrium of the pressures is reached in the male and in the female. Simultaneously, the compression-torsion spring 34 pushes the valve guide forward 31 even when the ball housing 70 and the inner body 40 have reached their forward end stop position, towards the front part of the female coupling, and the relative movement between the valve guide 31 and the peg 35 ensures that the latter slides along the second portion 36b of said sectioned guide 36 until it meets the connection zone 7 with the first portion 36a of said sectioned guide having a greater width. By effect of the torsional thrust exercised by the compression-torsion spring 34, the valve guide 31 rotates around the longitudinal axis thereof in an opposite direction to the direction in the above-described connection step until said peg 35 inserts itself in the recess 37a especially envisaged at the level of the connection zone 37. Rotation of the valve guide 31 around the longitudinal axis thereof is made possible, in addition to the fact that the peg 35 is at the level of the connection zone 37, also by the fact that the forward movement of the valve guide 31 has resulted in the disengagement of the rods 33 of the forked cam 32 from the grooves 31a envisaged in the rear zone of said valve guide 31.

When the peg 35 is at the level of the connection zone 37, the mechanical locking device 30, comprising the valve guide 31, the forked cam 32 with which said valve guide 31 interacts, and at least one compression-torsion spring 34 for the movement of said valve guide, maintains the valve guide and, thus, the valve body 11 in an open position. The situation, as mentioned, is the one shown in FIGS. 11 and 12, which shows the detail of the position of the peg 35 at the level of the connection zone 37 of the sectioned groove 36 of the valve guide 31. When the mechanical locking device 30 is in this position, the locking function in the open position of the valve body 11 of the female coupling is also ensured in the case of return flow having an elevated flow rate.

The valve guide 31 is thus mobile between a first forward position wherein the valve body 11 produces the closure of the flow of fluid in the female coupling, a second backward position, rotated about the longitudinal axis thereof against the torsion moment exercised by said compression-torsion spring 34 that allows backward movement of the valve body 11 to allow the connection of a male coupling 20, and a third forward position rotated around the longitudinal axis thereof by effect of the pair exercised by said compression-torsion spring 34 in a direction opposite to the first rotation and at the level of which the valve unit 11 of the female coupling and of the valve unit 21 of the male coupling open and prevent undesired backward movement of the valve unit 11 and, consequently, closures of the valve unit 21 of the male coupling 20.

It has thus been shown how the compact female coupling, of the push-pull type, equipped with mechanical locking device according to the present invention achieves the proposed aim and objects.

In particular, it has been illustrated how the present invention allows a female coupling equipped with a locking device that is characterised by a limited number of components to be produced, and thus for extremely compact dimensions with respect to the same type of couplings that are currently on the market.

It has again been shown how the female coupling of the push-pull type equipped with a valve locking mechanism is more reliable and has more contained production costs with respect to the couplings known in the prior art, above all in terms of the greater structural simplicity of the device.

Of the advantages of the present invention, the reduced dimensions of the quick coupling allows a more versatile use by the user in that smaller spaces are required for the assembly and operation of the coupling.

Numerous changes can be made by persons skilled in the art without deviating from the scope of protection of the present invention.

The scope of protection of the claims should not thus be restricted to the illustrations or to the preferred embodiments provided by way of example in the description; the claims should instead include all the characteristics of patentable novelty arsing from the present invention, including all the characteristics that are deemed to be equivalent by a person skilled in the art.

1. A female quick coupling device comprising a first axially mobile valve body for closing a flow of fluid in the female quick coupling device, configured to be connected, with a push-pull connection, to a corresponding male coupling device comprising a second axially mobile valve body for closing the flow of the fluid in the male coupling device, the first axially mobile valve body connected to a mechanical locking device of the first axially mobile valve body adapted to prevent the first axially mobile valve body from closing in the case of inversion of the flow of fluid, when the female quick coupling device is connected to the corresponding male coupling device.

2. The female quick coupling device according to claim 1, wherein the mechanical locking mechanism comprises a valve guide comprising a substantially cylindrical form, the valve guide being mobile in a longitudinal direction between a first forward position wherein the first axially mobile valve body achieves closure of a passage of the fluid flow in the female quick coupling device, a second backward position that is rotated about a longitudinal axis thereof, which allows the male coupling device to be connected to a third forward position that is rotated about the longitudinal axis thereof in an opposite direction to a first rotation at a level of which the first axially mobile valve body of the female quick coupling device and the second axially mobile valve body of the male coupling device open and that prevents undesired backward movements of the first axially mobile valve body, and consequently of closures of the second axially mobile valve body of the male coupling device.

3. The female quick coupling device according to claim 2, wherein the mechanical locking device comprises a valve guide having a substantially cylindrical form and comprising at least one pair of grooves in a diametrically opposed position on an outer surface of the valve guide, and a forked cam having a substantially cylindrical form and comprising at least one pair of rods, the grooves on the valve guide being suitable for housing the rods of the forked cam, the mechanical locking device further comprising at least one compression-torsion spring, which acts between the valve guide and an inner body also having a substantially hollow cylindrical form that is axially mobile with respect to an outer body of the female quick coupling device and at least one sectioned groove that houses a peg that is integrally associated with the inner body and adapted to produce the mechanical locking of the first axially mobile valve body of the female quick coupling device with respect to the inner body.

4. The female quick coupling device according to claim 3, wherein the rods of the forked cam comprise, at a level of a free end intended to come into contact with a portion of an inlet edge of the grooves of the valve guide, an oblique profile.

5. The female quick coupling device according to claim 4, wherein the sectioned groove comprises a first portion next to a rear portion of the valve guide, having a greater width, and a second portion that extends longitudinally towards a front portion of the valve guide, having a lesser width that is substantially coinciding with a width of the peg.

6. The female quick coupling device according to claim 5, wherein the first portion of the sectioned groove is connected to the second portion with a connecting zone which has a recess shaped so as to firmly house the peg.

7. The female quick coupling device according to claim 3, wherein the inner body comprises at a level of an inner surface thereof at least one longitudinal groove adapted to guide the forked cam in a translation movement thereof and at the same time prevent undesired movements about the longitudinal axis thereof.

8. A quick coupling device comprising a female quick coupling according to claim 1.
